(19) United States
(12) Patent Application Publication
(10) Pub. No.: US 2009/0058105 A1
(43) Pub. Date: Mar. 5, 2009

(54) TAMPER-EVIDENT SECURITY DEVICE AND MANUFACTURING METHOD

(75) Inventors: Paul A. LITTRELL, Fort Wayne, IN (US); Wanda K. BEARD, Angola, IN (US); David L. GILBERT, Fort Wayne, IN (US)

Correspondence Address: PILLSBURY WINTHROP SHAW PITTMAN, LLP, P.O. BOX 10500, MCLEAN, VA, 22102, US

(73) Assignee: BRAMMALL, Angola, IN (US)

(21) Appl. No.: 11/849,453

(22) Filed: Sep. 4, 2007

(51) Int. Cl. F16B 21/16

(52) U.S. Cl. 292/327

(57) ABSTRACT

A security device includes a securement washer having a securement washer hole, and a circumferential groove within the hole. An end cap includes a well that contains the securement washer, and an end cap circumferential wall that extends around the securement washer. A portion of the end cap circumferential wall extends over a circumferential portion of the securement washer located around the securement washer hole. The portion of the end cap circumferential wall comprises tamper-evident indicia on a surface thereof. The tamper-evident indicia is formed so as to remain unchanged until and unless the security device is tampered with. The security device may be manufactured by forming tamper-evident indicia such as a disturbance on a surface of an end cap such that the indicia remains unchanged until or unless the security device is tampered with. The tamper-evident indicia may be formed by an orbital forming process.

### BACKGROUND

This application relates to security devices and methods of manufacture thereof. In particular, this application relates to security seals for shipping containers that incorporate a bolt, and particularly to tamper-evident security seals. This application also concerns a method for manufacturing a tamper-evident security seal that incorporates a bolt.

Security seals are used widely in the shipping industry to provide a tamper-resistant closures for many different types of shipping containers and shipping receptacles. In one common example, one or more security seals are placed on the exterior of a shipping container (e.g., a container that is placed on a cargo ship for international shipping) after the contents of the container are verified.

There are many reasons for which a shipper might want (or be required) to seal a container after the contents of the container are placed therein. For example, for international shipping, customs requires that the freight container be sealed. In addition, in domestic shipping situations, there is often a need to seal a freight container for purposes of preventing tampering with the contents of the freight container.

Regardless of the reasons for which a security seal is employed, the security seal is expected to perform its intended function—namely to discourage opening of the container and to indicate if the container has been opened during transit for any reason. If the seal is broken, the recipient of the container will be able to quickly and easily determine that the container has been opened so that the recipient may reject the shipment, take appropriate corrective action, etc.

Of the many types of container seals that are known, one variety is referred to as a “bolt seal” because the security seal incorporates a bolt into its construction. Reference will now be made to FIGS. 26-29, which assist in providing an overview of the related art.

It is noted that the following discussion is intended to provide an overview of the related art to facilitate an understanding of various aspects of this disclosure described herein. A brief overview of some of the specific deficiencies in the conventional art is provided.

Bolt seals in the art typically are made from metal. As such, the seals do not include any indicia of color that may be used by a shipper to identify characteristics either of the shipping container or the contents of that container. For example, a shipper may wish to utilize seals with indicia of color to identify containers that are designated for international destinations. In another example, with respect to the contents of the container, the shipper may wish to employ different colored seals to indicate if the contents are fragile or perishable.

There are no standards in the shipping industry with respect to the use of color for particular shipments or containers. Accordingly, shippers may establish their own color schemes for the seals that they employ. In this regard, the colors that shippers select are individual (or specific) for that shipper.

As may be immediately apparent, when metal bolt seals are used to seal a container, without further modification, the seal has no color other than the color of the metal from which the seal is constructed. As would be appreciated by those skilled in the art, shippers typically do not apply color to the seals that they purchase because the application of color (e.g., by painting the seal) requires labor, which takes time and, therefore, adds cost.

Accordingly, in response to an increased interest from shippers, a need has arisen for bolt seals that incorporate color as an identifying feature. One difficulty with the manufacture of seals incorporating color lies in the fact that bolt seals traditionally are made from metal. Once a manufacturer chooses to supply bolt seals with indicia of color, the cost of the bolt seals increases for several reasons. Accordingly, at least from the standpoint of the manufacturer, a need has now arisen for bolt seals that incorporate indicia of color but that are not prohibitively expensive to manufacture.

Before explaining in greater detail some reasons why, at least with respect to the conventional art, manufacturing and supplying bolt seals with indicia of color is more expensive, a general overview of related bolt seals is provided below.

FIG. 26 illustrates features of a conventional bolt seal that is described in U.S. Pat. No. 4,802,699.

The bolt seal 10 includes a bolt 12 and a nut 14. The bolt 12 includes a head 16 connected to an elongated shaft 18. The elongated shaft 18 includes a tapered end 20, a plurality of parallel rings 22 and a plurality of grooves or notches 24. The nut 14 includes an end cap 26 and an interior security member 28, both of which cooperate with a first C-shaped ring 30 and a second C-shaped ring 32.

When the security seal 10 is installed on a freight container, the shaft 18 of the bolt 12 is inserted typically through structural members on the doors of shipping container. The nut 14 is then slid onto the shaft 18 until the nut 14 engages the parallel rings 22 on the shaft 18. The first and second rings 30, 32 are smaller in diameter than the shaft 18. Accordingly, when the C-shaped rings 30, 32 are introduced to the tapered end 20 of the shaft 18, the C-shaped rings 30, 32 expand to slide easily along the shaft 18. Once the C-shaped rings 30, 32 reach one of the grooves 24, however, the C-shaped rings 30, 32 return to their unexpanded shapes and, thereby, prevent the nut 14 from sliding in the opposite direction. A plurality of grooves 24 are provided to accommodate various sizes of shipping containers, as would be appreciated by those skilled in the art.

FIG. 27 illustrates a variation on the security seal 10 shown in FIG. 26. In this example, the security seal 34 also includes a bolt 36 and a nut 46. The bolt 36 includes a head 38 and a shaft 40. The end 42 of the shaft 40 opposite the head 38 has a tapered surface 42. A groove 44 is disposed in the shaft 40 near the tapered end 42 of the shaft 40. The nut 46 in this example has a cylindrical body with a closed end 48, defining a central bore 50. The central bore 50 defines a contoured bottom end 52. The central bore 50 defines a groove 54 in which a C-shaped ring 56 is disposed.

When the tapered end 42 of the bolt 36 is inserted into the central bore 50, the C-shaped ring 56 is captured by the grooves 44, 54 so that the nut 46 cannot be removed easily from the bolt 36. As also indicated, the nut 46 has a cylindrical outer surface 58 and a flat surface 60 on its bottom end.

In both of these conventional art examples, the bolts 12, 46 and the nuts 14, 46 are made from metal and do not include color identifiers.

In response to shipper interest in bolt seals that are provided with indicia of color, manufacturers have employed approaches like the one illustrated in FIGS. 28-29. The bolt seal is illustrated in FIGS. 28-29 may be found in U.S. Pat. No. Des. 514,425.

The bolt seal 68 includes a bolt 70, the cylindrical shaft of which is visible. A first end cap 72 is disposed over the nut (not shown) that engages one end of the bolt 70. The nut has the same construction as the nut 46 illustrated in FIG. 27. The first end cap 72 presents a broad surface 76 into which label information may be inscribed. The second end cap 74 is molded around the head of the bolt and presents a second surface 78 into which label information may be inscribed.

In the example illustrated in FIGS. 22 and 23, the first end cap 72 and the second end cap 74 are injection molded over the head of the bolt and over the body of the nut. While injection molding is entirely adequate for providing indicia of color, injection molding increases the cost of the bolt seal 68, which is disadvantageous in the marketplace.

In addition, because the first and second end caps 72, 74 are injection molded around the bolt 70, the end caps 72, 74 are permanently attached to the bolt and the nut. Accordingly, for the manufacturer that needs to have a variety of colors on hand for immediate shipment to a shipper, there is an increased cost associated with warehousing the myriad of colors in which the bolt seals 68 are manufactured.

Another example of shortcomings of known techniques includes the lack of ability to counter or detect tampering with security devices to surreptitiously gain entry to a container that is secured by known devices. As one example of tampering, heat may be applied to an end cap, and a tool may be used to straighten the folded over portion of the wall so that a bolt may be more easily disengaged from the security device. After the bolt is removed and the device security is breached, heat may again be applied and a tool may be used to rebend or refold the end cap.

In view of the foregoing, there are a number of issues raised by the conventional art for which a solution is sought.

### SUMMARY

One or more aspects or embodiments of this disclosure resolve one or more of the issues noted above with respect to conventional art security seals.

An embodiment of this disclosure provides a security device that includes a bolt with a head and a shaft, wherein the shaft defines at least one circumferential groove therein. The security device also includes a securement device, defining a hole with a diameter permitting the shaft of the bolt to be disposed therein, and at least one circumferential groove within the hole. A C-shaped ring is disposed within the circumferential groove. The security device also includes one of either (1) a first end cap defining a bolt head receiving well and a first end cap circumferential wall closeable around the head of the bolt after the bolt head is received in the bolt head receiving well, or (2) a second end cap defining a securement device receiving well and a second end cap circumferential wall closeable around the securement device after the securement device is received in the securement device receiving well.

In another aspect of one or more embodiments, the security device is a cylindrical body with a closed bottom end. In another aspect of one or more embodiments, the securement device has a body where the hole passes completely therethrough. In another aspect of one or more embodiments, the first end cap circumferential wall is closed around the bolt head via orbital peening. In another aspect of one or more embodiments, the second end cap circumferential wall is closed around the securement device via orbital peening. In another aspect of one or more embodiments, the first end cap and/or the second end cap are plastic.

An embodiment of this disclosure provides for a security device that combines a number of features including a bolt with a head and a shaft. The shaft defines at least one circumferential groove therein. A securement washer is included that defines a securement washer hole with a diameter permitting the shaft of the bolt to be disposed therethrough and at least one circumferential groove within the hole. A C-shaped ring is disposed within the circumferential groove within the securement washer. A first end cap is included that defines a bolt head receiving well, a first end cap hole through which the shaft of the bolt is disposed, and a first end cap circumferential wall extending above the head of the bolt once inserted into the bolt head receiving well. The first end cap circumferential wall permits the first end cap to be closed around the head of the bolt. A second end cap is also included that defines a securement washer receiving well and a second end cap circumferential wall extending above the securement washer once inserted into the securement washer receiving well. The second end cap circumferential wall permits the second end cap to be closed around the securement washer.

In another aspect of one or more embodiments, a security device is provided where the securement washer comprises a tapered end and the second end cap receiving well defines a tapered surface complimentary to the tapered end of the securement washer, thereby orienting the securement washer within the securement washer receiving well. In another aspect of one or more embodiments, the first end cap includes a label platform defining a label surface for label information. In another aspect of one or more embodiments, the second end cap includes a label platform defining a label surface for label information. In another aspect of one or more embodiments, the first end cap may be made of plastic. In another aspect of one or more embodiments, the first end cap circumferential wall may be folded over the head of the bolt, thereby closing the first end cap around the head of the bolt. In another aspect of one or more embodiments, the first end cap circumferential wall may be folded over the head of the bolt by an orbital peening process. In another aspect of one or more embodiments, the second end cap may be made of plastic. In another aspect of one or more embodiments, the second end cap circumferential wall may be folded over the securement washer, thereby closing the second end cap around the securement washer. In another aspect of one or more embodiments, the second end cap circumferential wall may be folded over the securement washer by an orbital peening process.

In another embodiment, a security device is provided with a bolt with a head and a shaft, wherein the shaft defines at least one circumferential groove therein, a securement nut, defining a hole with a diameter permitting the shaft of the bolt to be disposed therein, and at least one circumferential groove within the hole, the securement nut being closed at one end, and a C-shaped ring disposed within the circumferential groove. The housing defines a securement nut receiving well and a housing circumferential wall closeable around the securement nut after the securement nut is received in the securement nut receiving well.

In another aspect of one or more embodiments, the housing circumferential wall is closed around the securement nut via orbital peening. In another aspect of one or more embodiments, the housing is plastic. In another aspect of one or more embodiments, the housing includes a label platform defining a label surface for label information. In another embodiment, a method of manufacturing a security device includes providing a first end cap with a bolt head receiving well, inserting a bolt with a head into the bolt head receiving well until the head of the bolt is seated in the bolt receiving well, and closing the first end cap around the head of the bolt by folding a circumferential wall of the first end cap around the head of the bolt via an orbital peening process. In another aspect of one or more embodiments, the method includes providing a first end cap label platform on the first end cap, and applying label information to the first end cap label platform. The label information may be applied to the first end cap label platform by an inscribing process. Alternatively, the inscribing process may be a laser inscribing process.

In another embodiment, a method of manufacturing a security device includes providing a second end cap with a securement device receiving well, inserting a securement device into the securement device receiving well until securement device is seated in the securement device receiving well, and closing the second end cap around the securement device by folding a circumferential wall of the second end cap around the securement device via an orbital peening process.

In another aspect of one or more embodiments, the method includes providing a second end cap label platform on the second end cap, and applying label information to the second end cap label platform. The label information may be applied to the second end cap label platform by an inscribing process. Alternatively, the inscribing process may be by a laser inscribing process.

In another embodiment, a method of manufacturing a security device includes providing a first end cap with a bolt head receiving well and a first end cap hole, inserting a bolt with a head though the first end cap hole until the head of the bolt is seated in the bolt receiving well, providing a second end cap with a securement washer receiving well, inserting a securement washer into the securement washer receiving well, closing the first end cap around the head of the bolt, thereby securing the bolt within the first end cap, and closing the second end cap around the securement washer, thereby securing the securement washer within the second end cap.

In another aspect of one or more embodiments, an orbital peening process closes the first end cap around the head of the bolt by folding a first end cap circumferential wall over the head of the bolt. In another aspect of one or more embodiments, an orbital peening process closes the second end cap around the securement washer by folding a second end cap circumferential wall over the securement washer. In another aspect of one or more embodiments, a tapered end is provided on the securement washer, and a tapered surface is provided in the securement washer receiving well that compliments the tapered end of the securement washer. The securement washer is inserted into the securement washer receiving well such that the tapered end of the securement washer abuts the tapered surface in the securement washer receiving well. In another aspect of one or more embodiments, a first end cap label platform on the first end cap is provided so that label information may be applied thereon. In another aspect of one or more embodiments, label information is applied to the first end cap label platform by an inscribing process. In another aspect of one or more embodiments, the inscribing process is a laser inscribing process. In another aspect of one or more embodiments, a second end cap label platform is provided on the second end cap so that label information may be applied to the second end cap label platform. In another aspect of one or more embodiments, the label information is applied to the second end cap label platform by an inscribing process. In another aspect of one or more embodiments, the inscribing process is a laser inscribing process.

In a variant embodiment, a security device includes a securement washer having a securement washer hole, and a circumferential groove within the hole. An end cap, i.e., an end cap similar in some respects to the second end cap above includes a well that contains the securement washer, and an end cap circumferential wall that extends around the securement washer. A portion of the end cap circumferential wall extends over a circumferential portion of the securement washer located around the securement washer hole. The portion of the end cap circumferential wall comprises tamper-evident indicia on a surface thereof. The tamper-evident indicia is formed so as to remain unchanged the said security device is tampered with.

In a related variant embodiment, a method of manufacturing a security device includes providing an end cap similar in some respects to the second end cap above, and having a securement washer receiving well therein. A securement washer is inserted into the securement washer receiving well. The end cap is closed over a top circumferential portion of the securement washer so as to enclose the securement washer within the end cap. Tamper-evident indicia is formed on a surface of the end cap such that the tamper-evident indicia remains unchanged until the security device is tampered with.

Still further aspects of various embodiments of this disclosure will become apparent from the detailed description that follows.

### BRIEF DESCRIPTION OF THE DRAWINGS

This disclosure will be described with reference to drawings appended hereto, in which:

FIG. 1 is a side view illustration of one embodiment of a bolt seal of this disclosure;

FIG. 2 is a perspective illustration of a securement washer forming a part of the bolt seal of this disclosure;

FIG. 3 is a cross-sectional illustration of the securement washer depicted in FIG. 2;

FIG. 4 is a top plan view of the securement washer shown in FIG. 2;

FIG. 5 is a perspective illustration of a first end cap forming a part of the bolt seal of this disclosure;

FIG. 6 is a top plan view of the first end cap illustrated in FIG. 5;

FIG. 7 is a cross-sectional side view of the end cap depicted in FIG. 5;

FIG. 8 is an exterior side view of the first end cap shown in FIG. 5;

FIG. 9 is a bottom view of the first end cap illustrated in FIG. 5;

FIG. 10 is an exterior view of the label surface provided on the first end cap depicted in FIG. 5;

FIG. 11 is a perspective illustration of a second end cap forming a part of the bolt seal of this disclosure;

FIG. 12 is an exterior side view of the second end cap illustrated in FIG. 11;

FIG. 13 is a cross-sectional side view of the second end cap shown in FIG. 11;

FIG. 14 is a cross-sectional side view of the second end cap depicted in FIG. 11, the cross-section being taken at a plane disposed 90° from the plane of the cross-section illustrated in FIG. 13;

FIG. 15 is a bottom view of the second end cap illustrated in FIG. 11;

FIG. 16 is an exterior view of a label surface provided on the second end cap illustrated in FIG. 11;

FIG. 17 is a cross-sectional side view of a second embodiment of a bolt seal according to this disclosure;

FIG. 18 is a cross-sectional side view of the nut of the bolt seal illustrated in FIG. 17, before the nut is sealed into its associated housing;

FIG. 19 is a cross-sectional side view of the nut shown in FIG. 18, after the nut is sealed into its associated housing;

FIG. 20 is a side view illustration of a variant embodiment of a bolt seal of this disclosure showing an end cap having a tamper-evident surface disturbance on a top surface thereof;

FIG. 21 is a perspective illustration showing one particular example of the tamper-evident surface disturbance of bolt seal of FIG. 20;

FIG. 22 is an exterior side view of the end cap illustrated in FIG. 21 showing one example of the tamper-evident surface disturbance;

FIG. 23 is a cross-sectional side view of the second end cap shown in FIG. 21 showing one example of the tamper-evident surface disturbance;

FIG. 24 is a cross-sectional side view of the second end cap depicted in FIG. 21, the cross-section being taken at a plane disposed 90° from the plane of the cross-section illustrated in FIG. 23;

FIG. 25 is an exterior view of a label surface provided on an end cap illustrated in FIG. 21;

FIG. 26 is a cross-sectional side view of a bolt seal known in the conventional art;

FIG. 27 is a cross-sectional side view of another bolt seal known in the conventional art;

FIG. 28 is a perspective illustration of a top portion of yet another bolt seal known in the conventional art; and

FIG. 29 is a perspective bottom view of the known bolt seal illustrated in FIG. 28.

### DETAILED DESCRIPTION

Various embodiments of this disclosure will be described in connection with the figures appended hereto. The discussion of specific embodiments, however, should not be understood to convey that this disclosure is limited solely to those embodiments. Moreover, any reference to one embodiment or an aspect of one embodiment as “preferred” should not be understood to limit the scope of this disclosure in any way. To the contrary, as will be appreciated by those skilled in the art, this disclosure encompasses all equivalents of the structures, materials, and methodologies discussed, as would be appreciated by those skilled in the art.

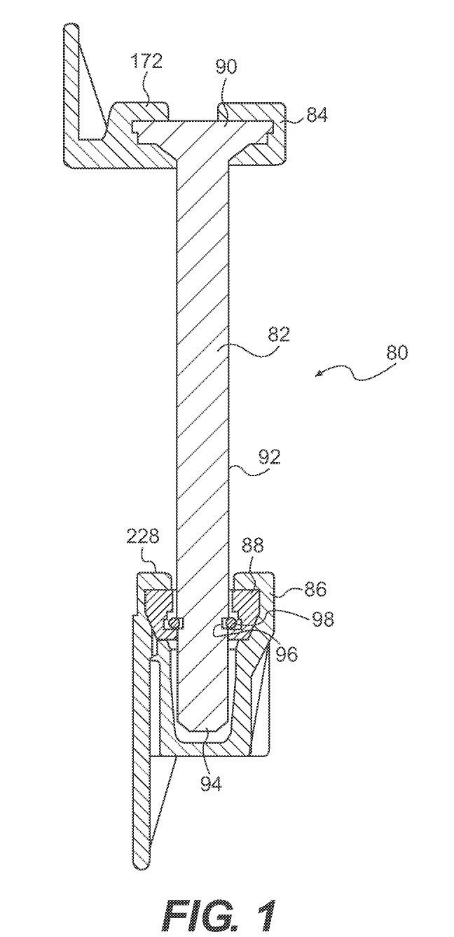

FIG. 1 illustrates one contemplated embodiment of a bolt seal 80 of this disclosure. The bolt seal 80 includes several components: a bolt 82, a first end cap 84, a second end cap 86, and a securement washer 88. Each of these components will be described in greater detail below.

As depicted in FIG. 1, the bolt 82 has a head end 90 to which an elongated shaft 92 is secured. The elongated shaft 92 extends to a tapered end 94. Near the tapered end 94, the shaft includes a circumferential groove 96.

In this embodiment, bolt 82 is a unitary structure made from a metal material such as cold rolled steel. Cold rolled steel may be useful at least because it is strong enough to maintain a secure seal on the opening to the shipping container and is a cost-effective material for construction of the bolt 82. Other materials may be employed including, but not limited to, stainless steel, iron, aluminum, magnesium, titanium, copper, and alloys thereof. In addition, it is contemplated that plastic or composite materials may be used to construct the bolt 82. As would be appreciated by those skilled in the art, the different materials that may be used to construct the bolt 82 are numerous. Accordingly, only a few representative examples are provided.

The shaft 92 of the bolt 82 may follow a straight line from end to end. However, as would be appreciated by those skilled in the art, some bolt seals include a slight bend in their shafts to accommodate different designs of shipping containers. While the bolt seal 80 of this disclosure is described in connection with a bolt 82 having a straight shaft 92, this disclosure is intended to encompass any bolt seal design, regardless of the shape or size of the shaft 92.

The circumferential groove 96 extends around the shaft 92 near the tapered end 94 of the bolt 82. The groove 96 may have any shape or dimension sufficient to capture a C-shaped ring 98 disposed with the securement washer 88. In one embodiment, the C-shaped washer 88 is made from steel. Of course, any other material may be employed including iron, aluminum, copper, titanium, nickel, or alloys containing these metals. Plastic and composite materials also may be employed as would be appreciated by those skilled in the art. As also would be appreciated by those skilled in the art, a C-shaped need not be employed in the securement washer 88. Alternative constructions for the securement washer 88 may be employed without departing from the scope of this disclosure.

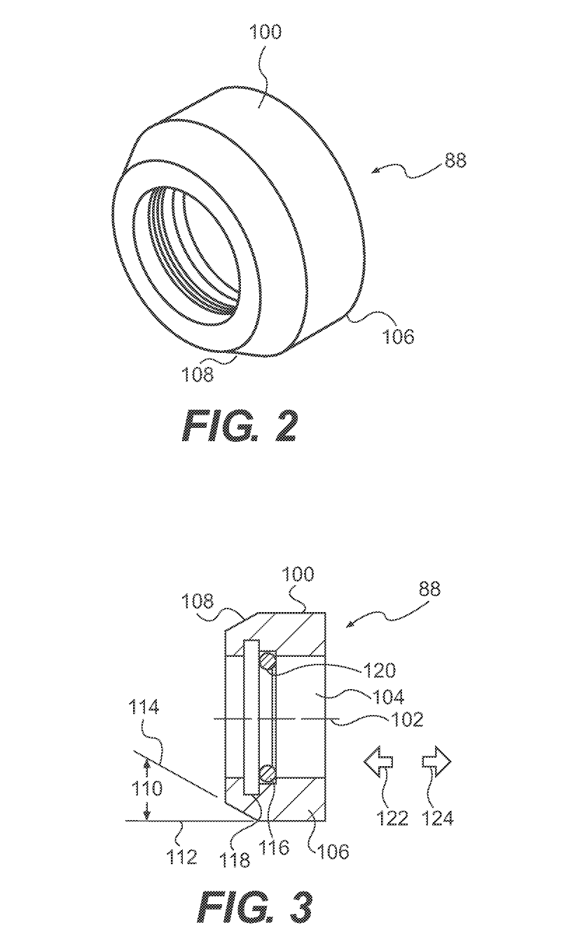

FIG. 2 provides a perspective illustration of the securement washer 88. In this embodiment, the securement washer 88 is a unitary construction. Of course, the securement washer could be constructed from two of more pieces that are connected together, as would be appreciated by those skilled in the art.

FIG. 3 is a cross-sectional illustration of the securement washer 88 of this disclosure. The securement washer 88 has a body 100 that is cylindrically-shaped about a central axis 102. The body 100 of the securement washer 88 defines a hole 104 through which the shaft 92 of the bolt 82 may pass. The body 100 has a cylindrical end 106 and a tapered end 108. It is noted that the tapered end 108 is not required to practice this disclosure. Accordingly, the tapered end 108 may be excluded from the securement washer without departing from the scope of this disclosure.

If included, the tapered end 108 defines an angle 110 between a reference line 112 and an angle line 114. Angle 110 may be between about 25° and 35° (degrees), or angle 110 may be between about 28° and 32°, or even about 30°. Among other advantages, the tapered end 108 assists in orienting the securement washer 88 within the within the second end cap 86, as will be described in greater detail below. Also, as with the manufacture of many devices, less material used for the construction of the securement washer helps to reduce the cost of the bolt seal 80.

The body 100 defines two grooves 116, 118 therein. In this embodiment, the first groove 116 has a smaller diameter than that of the second groove 118. A C-shaped ring 120 is inserted into the grooves 116, 118 to interlock with the groove 96 when the shaft 92 of the bolt 82 has been inserted therethrough. As would be appreciated by those skilled in the art, more than one ring may be employed to interlock with the groove 96 without departing from the scope of this disclosure. In addition, while the C-shaped ring 120 is illustrated with a circular cross-section, the C-shaped ring may have a square, rectangular, elliptical, oval, or other cross-section without departing from the scope of this disclosure.

To secure the securement washer 88 to the bolt 82, the tapered end 94 of the bolt 82 is inserted into the hole 104. Due to the taper, the tapered end 94 of the bolt 82 expands the C-shaped ring 120 until the bolt 82 has been inserted to the location containing the circumferential groove 96. At this point, the C-shaped ring 120 contracts to sit partially within the groove 96 and partially within the grooves 116, 118. Once seated within the groove 96, the securement washer 88 cannot be removed from the bolt 82 without applying a large amount of force.

For purposes of reference, the direction of insertion of the tapered end 94 of the bolt 82 into the hole 104 of the securement washer 88 is indicated by the arrow 122 in FIG. 3. The removal direction is indicated by the arrow 124. The first groove 116 facilitates insertion of the bolt 82 into the securement washer 88. Since the first groove 116 is smaller in diameter than the second groove 118, the C-shaped ring 120 will be pushed into the first groove 116 during the time that the bolt 82 is being inserted into the securement washer 88. Once the C-shaped ring 120 is captured by the groove 96, the C-shaped ring 120 will seat more fully in the second groove 118, which prevents the securement washer 88 from being easily removed from the bolt 82, as would be appreciated by those skilled in the art.

It is noted that the orientation of the securement washer 88 may be reversed, as would be appreciated by those skilled in the art. If reversed, the arrow 124 would indicate the insertion direction and the arrow 122 would indicate the removal direction. This disclosure is intended to encompass either orientation.

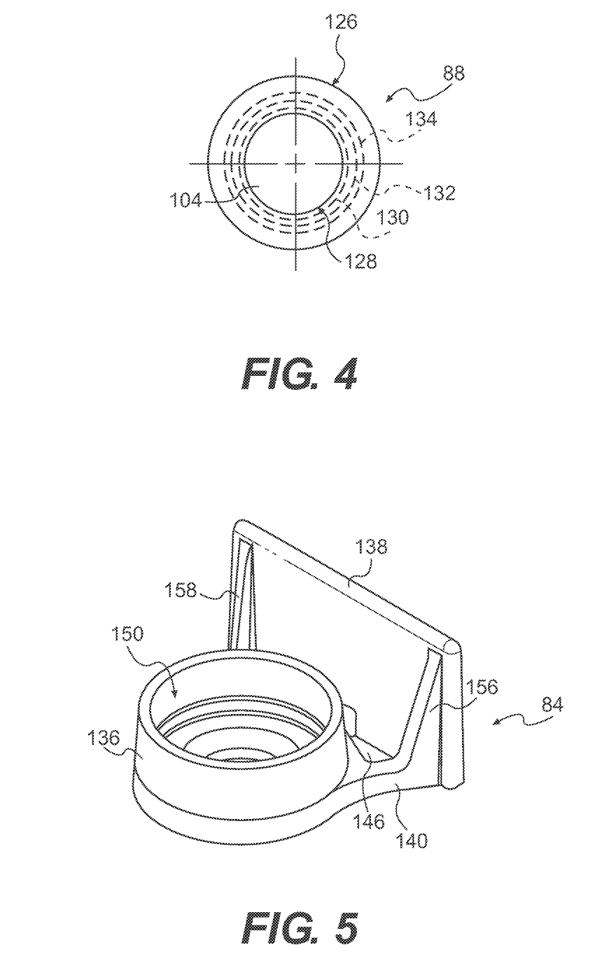

FIG. 4 provides a bottom plan view of the securement washer 88. The outer diameter 126 and inner diameter 128 of the securement washer 88 are plainly visible in this view. Also visible is the diameter 130 of the first groove 116, the diameter 132 of the second groove 118, and the diameter 134 of the tapered end 108. As would be appreciated by those skilled in the art, other diameters may be employed without departing from the scope of this disclosure and the relative sizes of the diameters of the structures in the securement washer 88 are provided merely for illustrative purposes of the various embodiments.

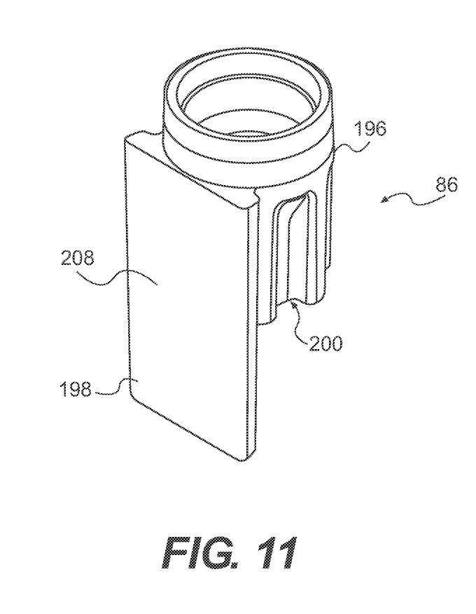

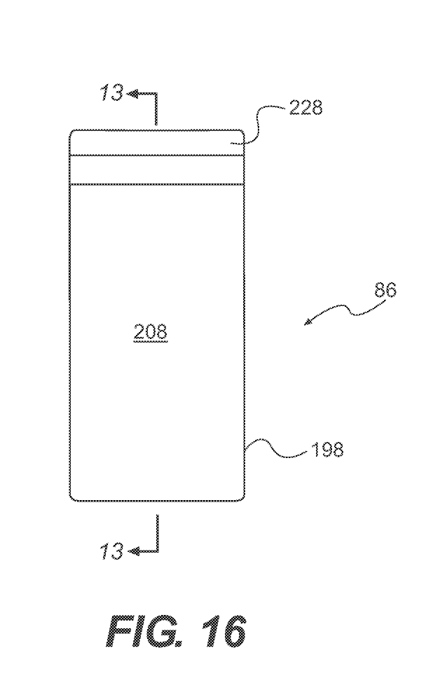

FIGS. 5-16 illustrate the various features of the first end cap 84 and the second end cap 86. FIGS. 5-10 illustrate various features of the first end cap 84. FIGS. 11-16 illustrate various features of the second end cap 86.

As illustrated in FIGS. 5-10, the first end cap 84 has two primary structures, a bolt head receiving housing 136 and a label platform 138.

While the label platform 138 may be incorporated into the first end cap 84, the label platform 138 is not required. Accordingly, while the label platform 138 is described in connection with the first end cap 84, the scope of this disclosure is intended to encompass constructions of the first end cap 84 that exclude the label platform 138.

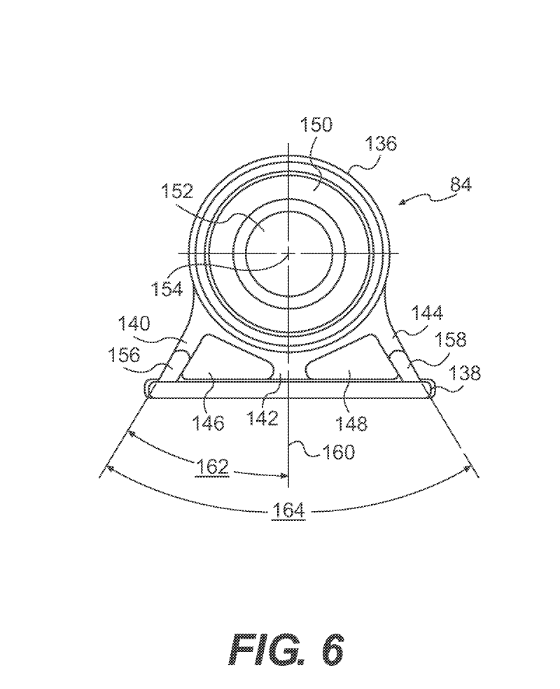

FIG. 6 is a top plan view of an embodiment of the first end cap 84. The bolt head receiving housing 136 and the label platform 138 are plainly visible in this view as are the first, second, and third bridges 140, 142, 144 that connect the bolt head receiving structure 136 to the label platform 138. A first opening 146 is defined between the first bridge 140 and the second bridge 142. A second opening 148 is defined between the second bridge 142 and the third bridge 144. As would be appreciated by those skilled in the art, the first and second openings 146, 148 are not required to practice this disclosure. However, in keeping with the design concept that less material results in a less costly device, inclusion of the first and second openings 146, 148 may be desired.

A bolt bead receiving well 150 is defined in the bolt head receiving structure 136. The bolt head receiving well 150 defines a hole 152 therein, which is circular in shape, at least in this embodiment. Being circular, the hole 152 defines a central axis 154.

So that the label platform 138 is securely attached to the bolt head receiving structure 136, the first bridge 140 and the third bridge are provided with first and second reinforcing structures 156, 158, respectively. As would be appreciated by those skilled in the art, the first and second reinforcing structures are not required to practice this disclosure.

As illustrated in FIG. 6, the second bridge 142 is located along a centerline 160 extending from the central axis 154 through the label platform 138. The first bridge 140 is disposed at an angle 162 from the centerline 160. The angle 162 may be between about 25° and 35° and, in other aspects of this embodiment, the angle 162 may be between about 28° and 32°, or about 30°. The third bridge 144 also may be disposed at the same angle as the first bridge 140 from the centerline 160. Accordingly, in one embodiment, the angle 164 between the first bridge 140 and the third bridge 144 is about 60°.

In one embodiment of this disclosure, the first end cap 84 is made from a moldable plastic material. While plastic is one option, other materials may be employed in the construction of the first end cap 84. For example, the first end cap may be made from metal, an alloy, or a composite material.

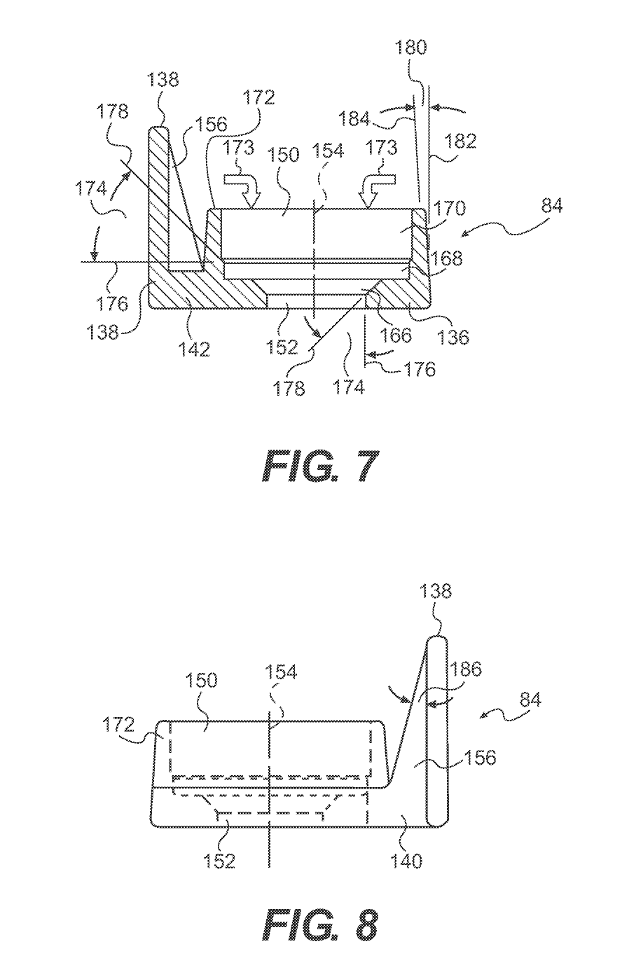

FIG. 7 presents a cross-sectional side view illustration of the first end cap 84 (as indicated in FIG. 10) taken through the centerline 160. As illustrated, the bolt head receiving well 150 includes three separate areas that are in communication with the hole 152. The first area 166 is a frusto-conically-shaped area immediately adjacent to the cylindrically-shaped hole 152. The frusto-conically-shaped first area 166 is incorporated into the first end cap 84 to accommodate material that extends between the shaft 92 and the head 90 of the bolt 82. The second area 168 may be a cylindrically-shaped area into which the head 90 of the bolt 82 rests after the shaft 92 has been inserted through the hole 152. The third area 170 may be a cylindrically-shaped area with a slightly larger diameter than the second area 168.

A cylindrically-shaped wall 172 of the bolt head receiving well 150 extends upwardly from the second area 168. The cylindrically-shaped wall 172 provides material that may be folded over, in the direction of the arrows 173 to cover at least a portion of the head 90 of the bolt 82. When the wall 172 has been folded over the head 90, the bolt 82 and the first end cap 84 are secured to one another. The folding of the wall 172 over the head 90 will be described in greater detail below.

While one embodiment of the first end cap provides a wall 172 that may be folded over the top of the head 90 of the bolt 82, it is contemplated that a reverse orientation also may be employed. Specifically, a wall may be provided that could be folded over the bottom of the head 90 of the bolt 82. Accordingly, this reverse orientation also is considered to be encompassed by this disclosure.

It is noted that the first area 166, the second area 168, and the third area 170 are merely provided to describe the embodiment illustrated. As would be appreciated by those skilled in the art, the first, second, and third areas 166, 168, 170 may be merged into a single area depending upon the design selected by the manufacturer. As a result, to practice this disclosure, it is not required to include the first, second, and third areas 166, 168, 170 in the first end cap 84. The scope of this disclosure intentionally encompasses any number of areas incorporated therein.

As illustrated in FIG. 7, the wall of the frusto-conically-shaped first area 166 may be shaped to form an angle 174 between a reference line 176 and an angle line 178 of about 45°. The angle 174 need not be 45°, as would be appreciated by those skilled in the art.

In the embodiment illustrated, the wall 172 does not have a uniform thickness. In one embodiment, wall 172 does not have a uniform thickness. As illustrated, the top of the wall 172 is thinner than the bottom part of the wall 172. The wall 172 may thin at an angle 180 defined between a reference line 182 and an angle line 184. The angle 180 may be about 5°. The angle 180 may be larger or smaller than 5° as required or desired by the manufacturer of the first end cap 84.

FIG. 8 presents a side view of the first end cap 84. As illustrated, the reinforcing structure 156 may have a decreasing thickness from the bolt head receiving structure 136 to an exterior edge of the label platform 138. The decreasing thickness may form an angle 186 that is about 15°. As would be appreciated by those skilled in the art, the angle 186 may be larger or smaller than 15° as required or desired by the manufacturer of the first end cap 84. The second reinforcing structure 158 may be constructed in the same manner.

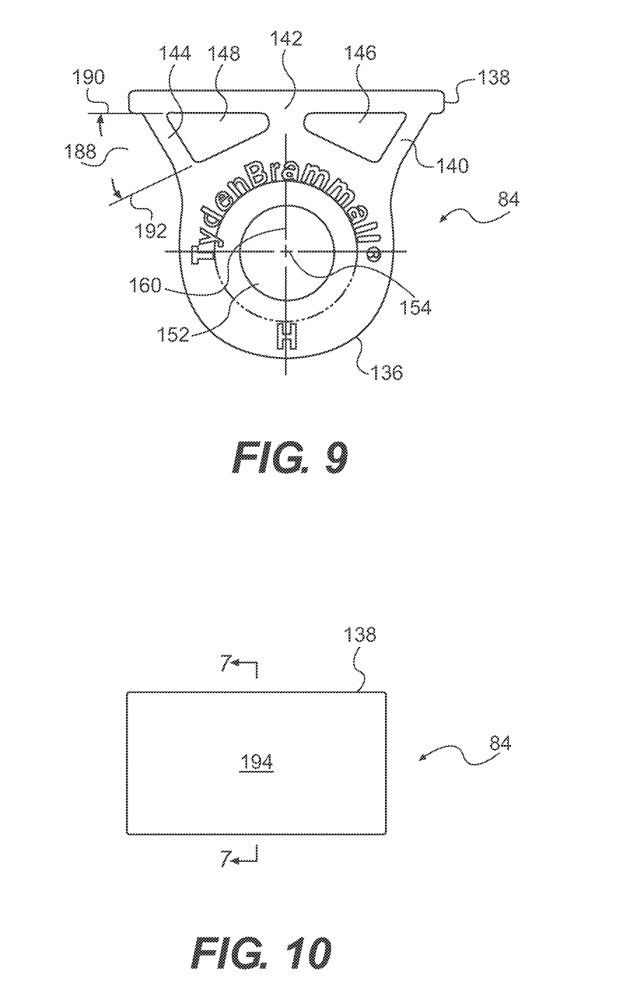

FIG. 9 provides a bottom view of the first end cap 84. As illustrated, the second opening 148 has a generally triangular shape that defines an angle 188 between a reference line 190 and an angle line 192. In one embodiment, the angle 188 may be about 25°. As would be appreciated by those skilled in the art, the angle 188 may be larger or smaller than 25° as required or desired by the manufacturer of the first end cap 84. The shape of the first opening 146 may be a mirror image of that of the second opening 148.

FIG. 10 is a plan view of the label platform 138 on the first end cap 84. The label surface 194 is shown as a generally rectangular structure. A rectangular label surface 194, however, is not required. The label surface 194 may take any shape as required or desired by the manufacturer of the first end cap 84.

As would be appreciated by those skilled in the art, label information may be indelibly inscribed onto the label surface 194. The label information, which typically includes a unique serial number, may be inscribed using one of many known techniques. For example, the label information may be inscribed using a mechanical inscribing device or a laser inscribing device. Any other method, including the use of an ink jet printer or adhesive labels, also may be employed, as desired.

FIGS. 11-16 illustrate various features of the second end cap 86 of this disclosure. Like the first end cap 84, the second end cap 86 includes two primary components, a securement washer receiving structure 196 and a label platform 198. As with the first end cap 84, in the second end cap 86, the securement washer receiving structure 196 is connected to the label platform 198.

As with the first end cap 84, while the label platform 198 may be incorporated into the second end cap 86, the label platform 198 is not required. Accordingly, while the label platform 198 is described in connection with the second end cap 86, the scope of this disclosure is intended to encompass constructions of the second end cap 86 that exclude the label platform 198.

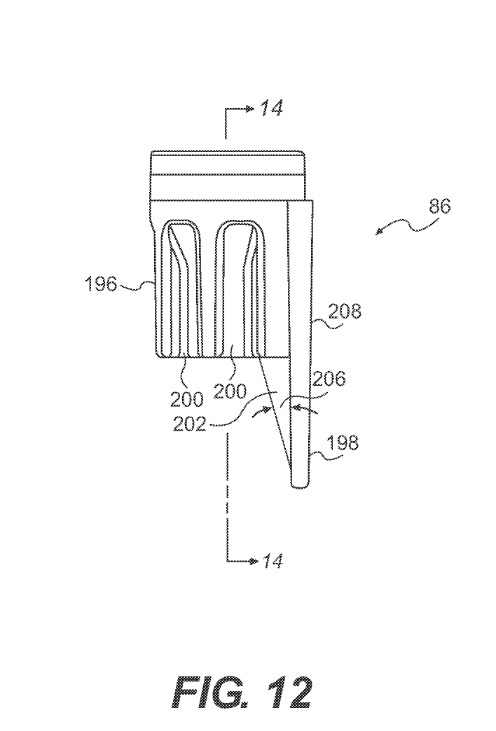

FIG. 12 provides a side view of the second end cap 86. Since the second end cap 86 contains the securement washer 88, the second end cap 86 is a component separate from the first end cap 84 that contains the bolt 82. To facilitate insertion of the tapered end 94 of the bolt 82 into the securement washer 88, the second end cap 86 includes a plurality of recesses 200 therein, which help the user to grasp the second end cap 86. In addition, the inclusion of recesses 200 reduces the amount of material required to construct the second end cap 86 and, therefore, reduces the cost of manufacture of the second end cap 86.

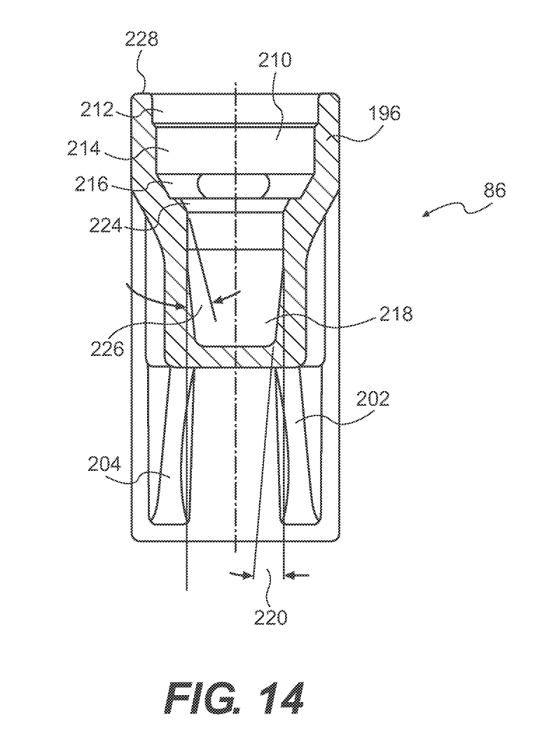

As illustrated in FIG. 12, the label platform 198 is attached to the securement washer receiving structure 196 via two reinforcing structures 202, 204 (see FIG. 14). The thickness of the reinforcing structures 202, 204 increases at an angle 206 that is about 15° in one embodiment. As would be appreciated by those skilled in the art, the angle 206 may be larger or smaller than 15° as required or desired by the manufacturer of the second end cap 86.

As the various illustrations of the second end cap make clear, the label platform 198 defines a label surface 208. The label surface 208 will be described in greater detail below.

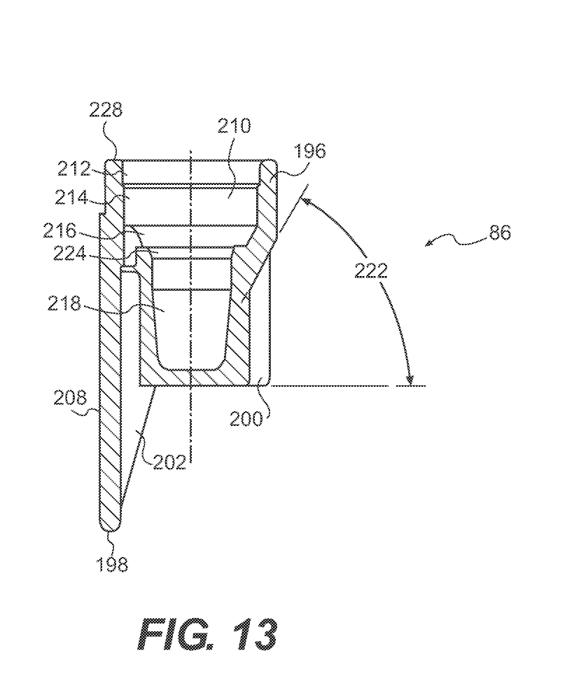

FIG. 13 is a cross-sectional view of the second end cap 86. The structures illustrated as the same as discussed above. This illustration makes more clear the internal structure of the second end cap 86. In particular, FIG. 13 illustrates the securement washer receiving well 210. The securement washer receiving well 210 includes at least a first area 212, a second area 214, a third area 216, and a fourth area 218.

When the securement washer 88 is placed into the securement washer receiving well 210, the securement washer 88 occupies the second area 214 and the third area 216. The third area 216 is frusto-conically shaped to accommodate the tapered end 108 of the securement washer 88. This assures that the securement washer 88 is correctly oriented within the second end cap 86, among other advantages.

As with the first end cap 84, the second end cap 86 need not incorporate the first, second, third, and fourth areas 212, 214, 216, 218. To the contrary, a fewer number or a greater number of areas may be employed. This disclosure, therefore, is intended to encompass a structure that includes at least one area. The discussion of the first, second, third, and fourth areas 212, 214, 216, 218 is merely provided to discuss exemplary details of an embodiment of the second end cap 86.

After the securement washer 88 is positioned with the securement washer receiving well 210, the cylindrical wall 228 at the top of the securement washer receiving well 210 is machined (see FIG. 1) to secure the securement washer 88 within the second end cap 86. As with the first end cap 84, the end of the cylindrical wall 288 is folded over, via a suitable machining process, to capture the securement washer 88 in the second end cap 86.

As with the first end cap 84, it is contemplated that a reverse orientation may be employed to secure the securement washer 88 in the second end cap 86. Specifically, rather than providing the wall 228 at the top of the second end cap 86, a wall may be provided at the bottom of the second end cap 86. In this reverse orientation, the securement washer 88 would be inserted through the bottom of the second end cap 86 and a wall at the bottom would be folded over the securement washer 88. Both orientations are intended to be encompassed by this disclosure.

As illustrated in FIGS. 13 and 14, the fourth area 218 of the securement washer receiving well 210 is a tapered frusto-conically shaped chamber that accommodates the tapered end 94 of the bolt 82 once inserted through the securement washer 88. The tapered surface may be angled at 5°, as shown in FIG. 14. As would be appreciated by those skilled in the art, the angle may be greater or less than 5°.

Returning to FIG. 13, the top ends of the recesses 200 include a surface that is disposed at an angle 222 of about 60°. The angle 222 may be greater or less than 60° as required or desired by the manufacturer of the second end cap 86. As illustrated in the embodiment of FIG. 14, a fifth area 224 of the securement washer receiving well 210 has a wall disposed at an angle 226 of about 15°. This angle 226 may be greater or less than 15° as required or desired by the manufacturer of the second end cap 86.

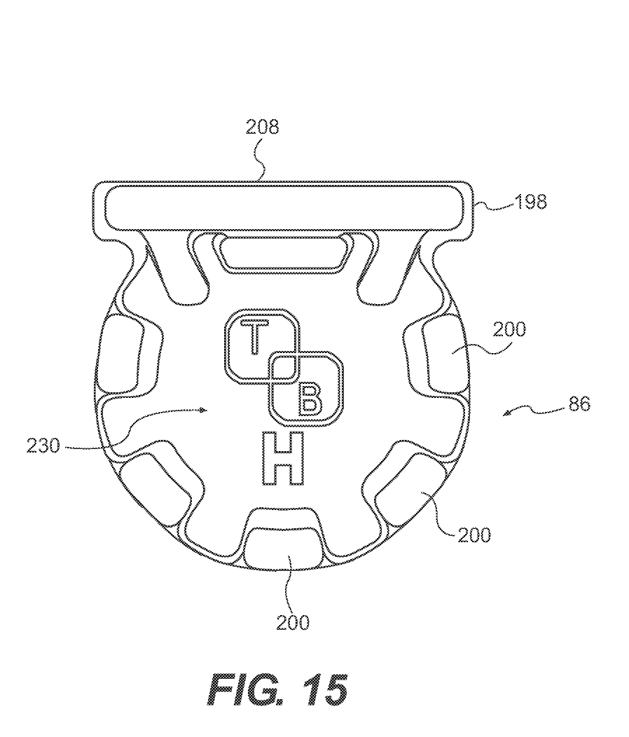

FIG. 15 provides a bottom plan view of the second end cap 86 of this disclosure. The recesses 200 are clearly visible in this view. The bottom end of the second end cap 86 may be provided with identifying information 230 about the bolt seal 80.

This disclosure is not intended to encompass only a security seal 80 that includes both the first end cap 84 and the second end cap 86. It is contemplated that one of the first end cap 84 or the second end cap 86 may be excluded from the security seal. This disclosure is intended to encompass a construction where only one of the first end cap 84 or the second end cap 86 is employed.

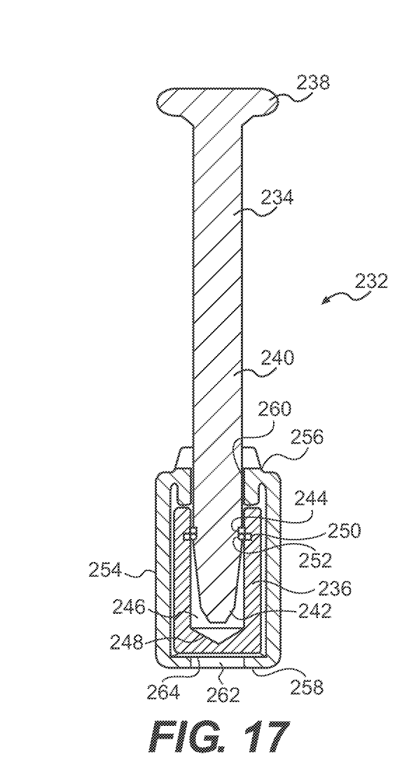

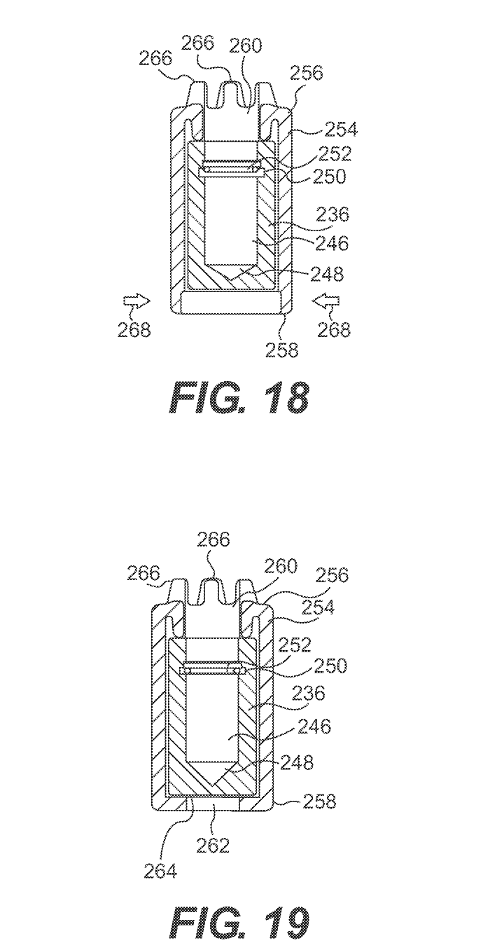

FIG. 17 is a cross-sectional side view of a second embodiment of a bolt seal 232 according to this disclosure.

In this embodiment, the bolt seal 232 includes a bolt 234 and a nut 236. The bolt 234 includes a head 238 and a shaft 240 with a tapered end 242. Near the tapered end 242 of the shaft 240, a groove 244 is provided therein. The nut 236 essentially is a cylindrically-shaped body with a central bore 246 having a contoured bottom end 248. A groove 250 is defined by the bore 246 and contains a C-shaped ring 252. When the tapered end 242 of the bolt 234 is inserted into the central bore 246 of the nut 236 so that the grooves 244, 250 align, the C-shaped ring 252 will be captured by the grooves 144, 250 so that the nut 236 may not be removed easily from the bolt 234.

The nut 236 is provided with a housing 254. In the illustrated embodiment, the housing 254 is a cylindrically-shaped body with a top end 256 and a bottom end 258. The top end has a bore 260 therethrough, permitting the shaft 240 of the bolt 234 to pass therethrough into the central bore 246 of the nut 236. The housing 254 includes one or more protrusions 266 extending from the top end 256 thereof. In its assembled state, as shown in FIG. 17, the bottom end 258 of the housing defines an opening 262 therethrough, which exposes a bottom surface 264 of the nut 236.

In one embodiment, as with the first embodiment of this disclosure, the housing 254 is constructed from plastic or other suitable material that is imbedded with or is otherwise provided with indicia of color. A colored plastic may be used, but other materials may be employed without departing from the scope of this disclosure, as would be appreciated by those skilled in the art.

A method of manufacture of the bolt seal 80 will now be provided. As discussed in greater detail, the method of manufacture offers considerable advantages to the manufacture of bolt seals, such as the bolt seal 80 of this disclosure.

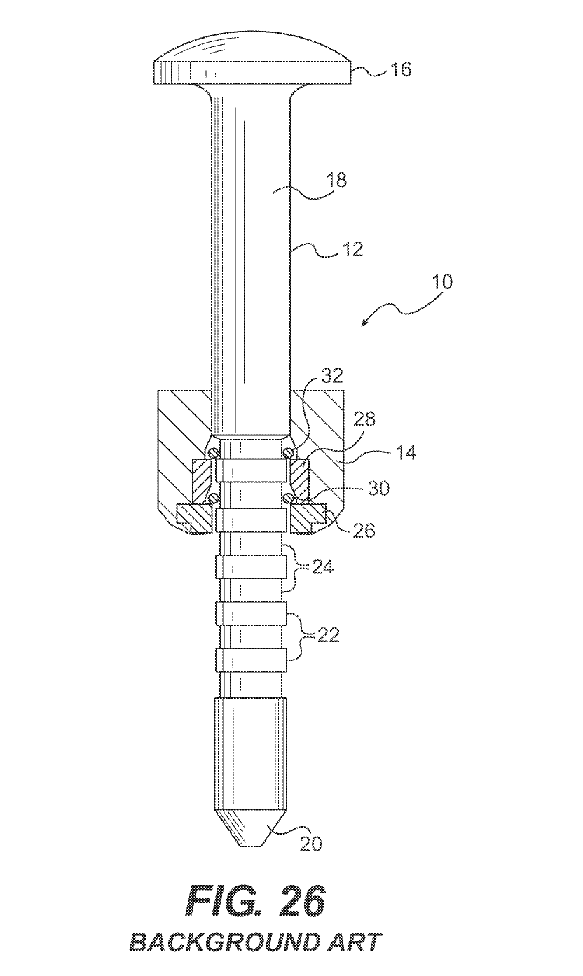

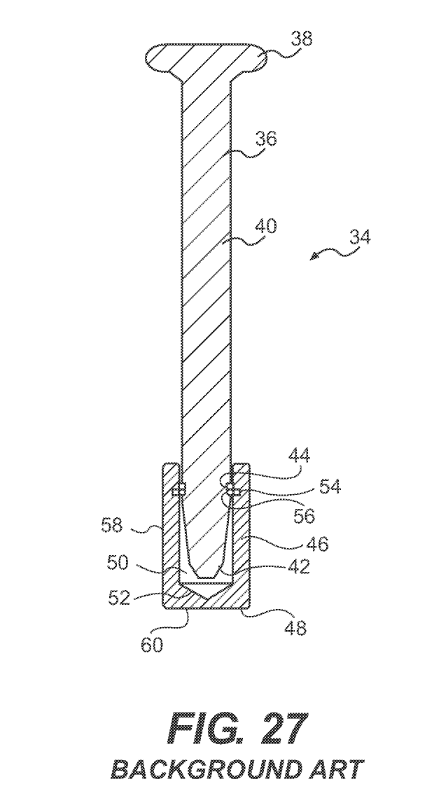

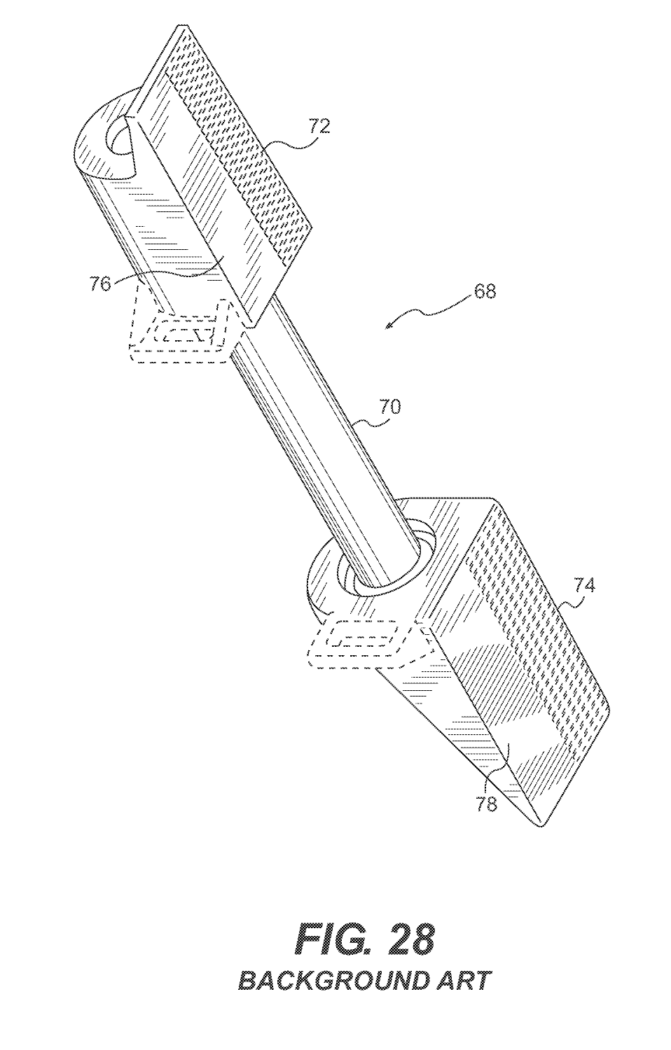

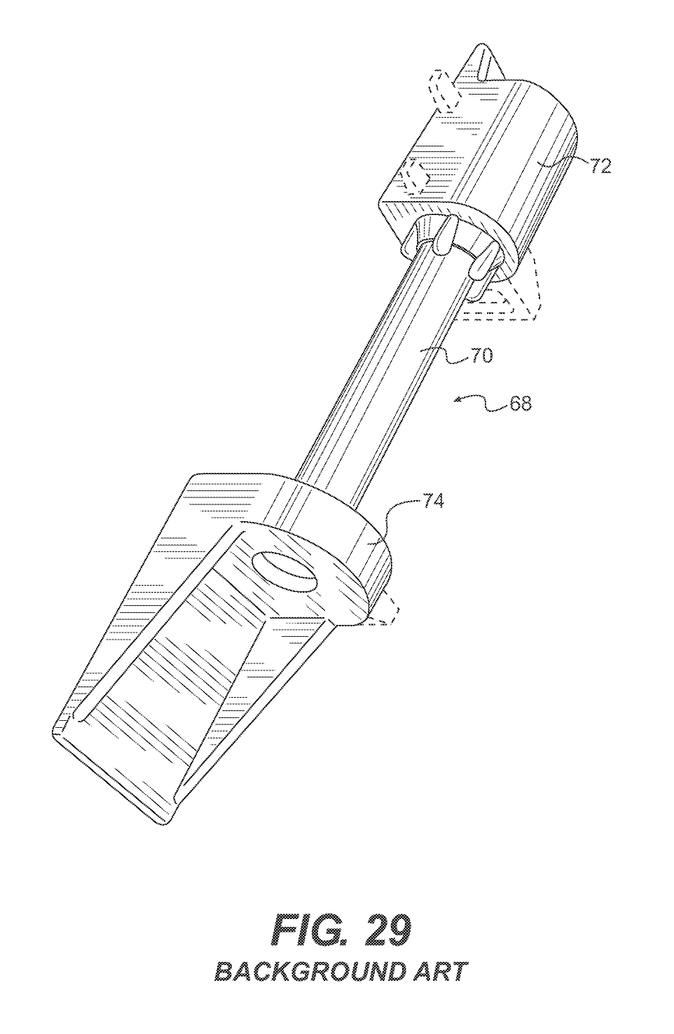

In the conventional art, as discussed above in connection with FIGS. 26-29 (and U.S. Design Pat. No. Des. 514,425), it is known to mold plastic end caps around the head of the bolt and around the securement device that is affixed to the end of the bolt. As noted, in this construction, the securement device is a closed-ended metal nut (e.g., nut 46). As also noted, this construction present two challenges to a manufacturer of bolt seals. First, for securement purposes, it is not necessary to employ a securement device that is a closed structure made completely of metal, as in the case of the nut 46. The reasons for this are many-fold. Cost is one factor. If the securement device is completely as a closed metal structure, the cost of manufacturing the securement device is increased. Second, when the end caps, such as the end caps 72, 74 are injection molded around the head of the bolt and the closed metal securement device, a warehousing problem is created that adds to the cost of the bolt seal 68, as discussed above.

The inventors of this disclosure recognized that it would be eminently more practical if the end caps 84, 86 could be manufactured separately from the bolt 82 and the securement washer 88 and attached to the bolt 82 and securement washer 88 before being sold to a shipper. In this way, the manufacturer of the bolt seal 80 need keep on hand only an assortment of different colored end caps 84, 86 and a reasonable supply of bolts 82 and securement washers 88.

The inventors of this disclosure also recognized that the securement washer 88 could be altered from the securement device known in the conventional art. Specifically, the securement washer 88 could be made to be considerably smaller in size and weight than the securement device known in the art. This assists in reducing the cost associated with the manufacture of the security bolt 80.

As the foregoing makes clear, however, this disclosure is intended to encompass security seals that incorporate either the securement washer 88 or the nut 236.

To manufacture the security bolt 80, the bolt 82 is first inserted through the hole 152 in the first end cap 84. Once fully inserted, the head 90 of the bolt will abut the bottom surface of the bolt head receiving well 150. In this stage, the cylindrical wall 172 extends above the top surface of the head 90 of the bolt 82.

To secure the bolt 82 in the first end cap 84, the wall 172 may be folded over the end of the head 90 of the bolt 82 as illustrated in FIG. 1. The wall 172 may be folded over the head 90 of the bolt 82 using any of a number of different folding methodologies and techniques. In one embodiment, the wall 172 is folded over the head 90 using an orbital riveting or orbital peening technique.

Orbital riveting refers to a manufacturing technique that is typically utilized to rivet two metal components together. U.S. Pat. Nos. 5,855,054 and 6,161,273 are representative of this orbital riveting technique and are incorporated herein by reference. Orbital peening refers to the same manufacturing technique as it applies to materials other than metals.

In the orbital peening process, pressure is applied by a rotating head to the walls 172, 228, 258. As the head rotates around the walls 172, 228, 258, the head applies pressure to press the walls 172, 228, 258 inwardly, thereby securing the bolt 82, the securement washer 88, or the nut 236 in the first end cap 84, the second end cap 86, or the housing 254.

As would be appreciated by those skilled in the art, other techniques may be used to secure the bolts 82, the securement washers 88, and the nuts 236 in the first and second end caps 84, 86 or the housing 254. For example, a heating technique may be used. Alternatively, a plastic cap could be adhered or sonically welded in place. Other techniques, as would be known to those skilled in the art, also may be employed without departing from this disclosure.

As noted, the orbital peening technique may be useful because it does not require adhesives, the application of heat, or the need for additional plastic components (e.g., caps) to manufacture the security bolt 80, 232.

It is also noted, for purposes of reference, that the securement washer 88 and the securement nut 236 are generally referred to as securement devices. In other words, the term “securement device” is intended to encompass the securement washer 88, the securement nut 236, and any equivalents thereof, all of which are intentionally encompassed by this disclosure.

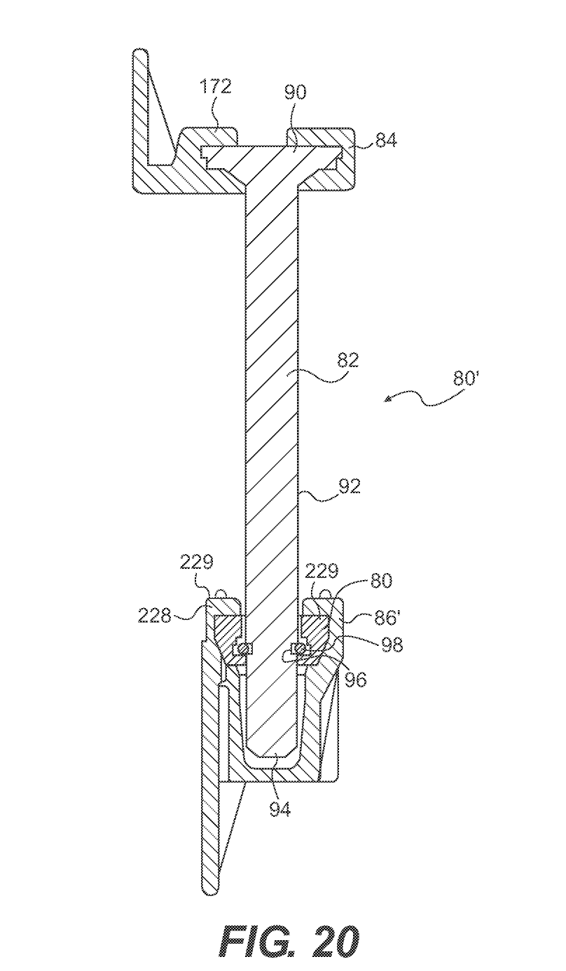

In an alternative embodiment depicted in FIG. 20, a tamper-evident securement device or bolt seal 80′ is generally arranged as previously described above with respect to securement device or bolt seal 80, but further includes the addition of surface disturbance 229 on at least a top surface or portion of cylindrical wall 228 that is a part of tamper-evident second end cap 86′. Surface disturbance 229 may comprise one or more of a surface wrinkle or one or more bumps formed on the top surface or portion of cylindrical wall 228. Optionally, surface disturbance 229 may comprise letters and/or numerals, or raised letters and/or numerals. As in previously described embodiments, tamper-evident second end cap 86′ and surface disturbance 229 may be made of a plastic material, for example.

The tamper-evident indicia is formed and configured to remain relatively unchanged until/unless the security device is tampered with. Upon an attempt to open the securement device 80′ and/or reclose the device in either an overt or surreptitious manner, the tamper-evident indicia will be permanently altered so as to provide an indication that access to a shipping container, for example, authorized or not, has been attempted or carried out. For example, tampering may be attempted by prying after a heat gun, hair dryer, or steam is applied to the second end cap 86′, and heat is again applied to allow bending of the top portion of second end cap 86′. The application of heat has been found to make the surface disturbances 229, e.g., “bumps”, to “smooth out” or otherwise distort.

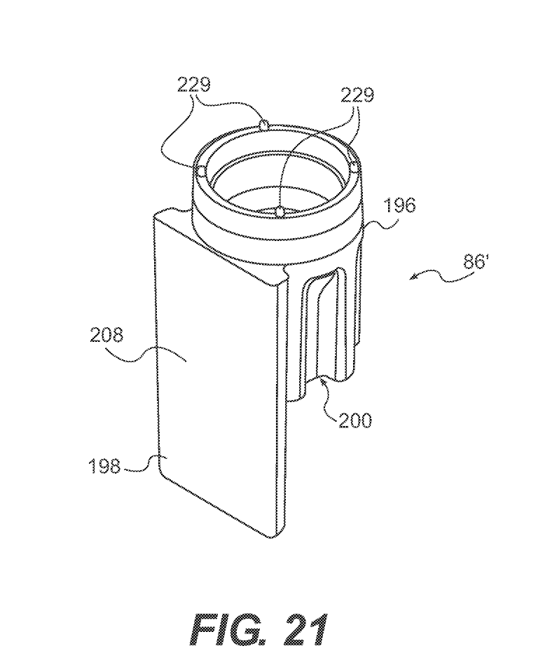

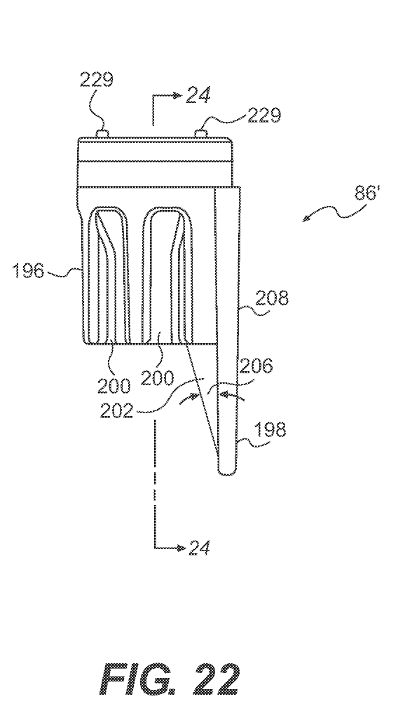

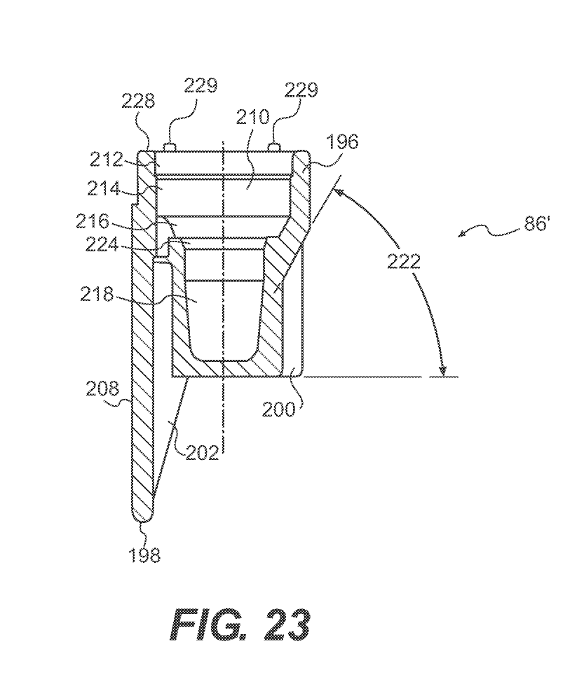

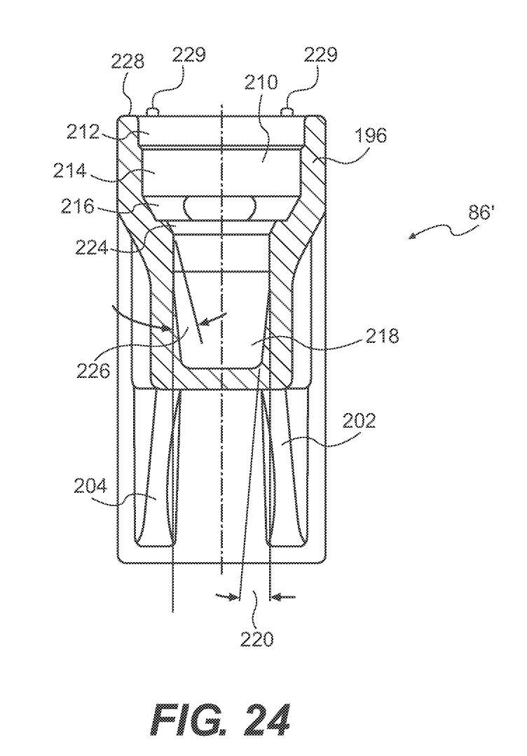

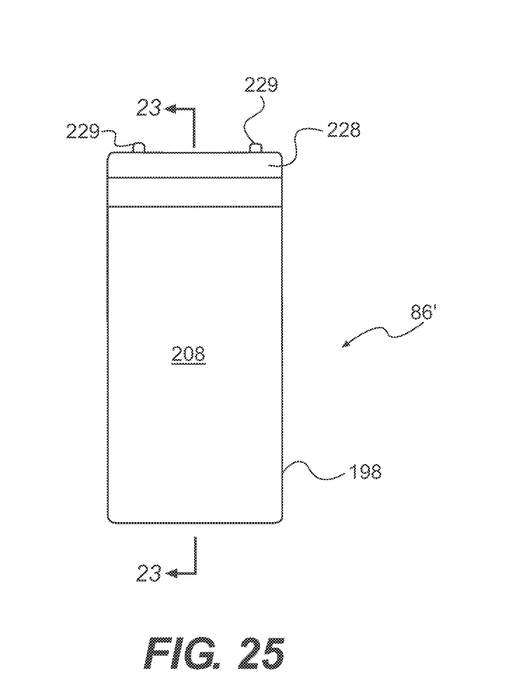

Further views of tamper-evident bolt seal 80′ and/or tamper-evident second end cap 86′ are provided in FIGS. 21-25 showing the various interrelationships of an exemplary embodiment of surface disturbances 229 to other portions of the tamper-evident security device 80′.

A method of manufacturing the tamper-evident security device of this variant embodiment is similar in many respects to the previously-described methods, except that tamper-evident indicia 229 are formed on a surface of the second end cap 86′ formed from a portion of the second end cap circumferential wall 228. In one or more variant embodiments, the tamper-evident indicia 229 may be formed as a surface disturbance on the surface of the portion. The tamper-evident indicia 229 may include, for example, one or more of a surface wrinkle, one or more bumps, and/or letters/numerals including raised letters and/or numerals formed on the top surface or portion of cylindrical wall 228, i.e., on a top surface of the second end cap.

In one aspect of a variant embodiment above, the second end cap may be closed by an orbit forming process, and in a further aspect, the forming of tamper-evident indicia is carried out by and simultaneously with the orbit forming process. The orbital tool head used in this particular aspect may be configured to provide one or more “bumps” or other indicia described above to disturb the orbitally-formed surface by an indentation, for example, in the otherwise flat surface of the orbital tool head.

More generally, closing the second end cap may be carried out by folding or enclosing a second end cap circumferential wall over the securement washer and, in a further aspect, the forming of tamper-evident indicia is performed simultaneously with the folding or enclosing of the second end cap.

Similar to the earlier embodiments previously discussed, first and/or second end cap label platforms may also be provided on the first and/or second end caps, respectively, to enable the application of label information to one or both of the end cap label platforms. The labels may be inscribed, e.g., by a laser inscribing process.

As one example of tampering, heat may be applied to the top surface portion of cylindrical wall 228 of second end cap 86′, and a tool may be used to straighten (e.g., by prying) the folded over portion of wall 228 so that a bolt may be more easily disengaged from the securement device 80′. After the bolt is removed and the securement device is breached, heat may again be applied with a tool to rebend or refold wall 228. The presence of tamper-evident indicia 229 make any such surreptitious breach of device 80′ more difficult, if not impossible, to conceal. When wall 228 and tamper-evident indicia 229 are heated to open device 80′, for example, and while wall 228 may be able to be reformed over the securement washer 88, tamper-evident indicia 229 will not be able to be reformed without remanufacturing second end cap 86′, because the surface disturbance or tamper-evident indicia 229 are caused to smooth out or otherwise distort and disappear.

Reference to elements above as being “first” or “second” are not to be construed as limiting in any sense, as these are relative terms used merely to aid in an understanding of this disclosure.

As would be appreciated by those skilled in the art, there are many alternative ways in which to practice this disclosure, as would be understood by those skilled in the art. The embodiments described herein are merely representative of the broad scope of this disclosure.

1. A security device, comprising:
a bolt with a head and a shaft, wherein the shaft has at least one circumferential groove at least partially therearound;
a securement washer comprising:
a securement washer hole configured to at least partially receive the shaft of the bolt therethrough, and
a circumferential groove at an inner surface of the securement washer; and an end cap comprising:
a well that receives the securement washer therein, and
an end cap circumferential wall that, when the securement washer is not received in the well, is configured to receive the securement washer through a passageway defined by the end cap circumferential wall, and when the securement washer is received within the well, the end cap circumferential wall is formed at least partially over a proximate end of securement washer, wherein a portion of the end cap circumferential wall extends over a circumferential portion of the proximate end of the securement washer and generally around the securement washer hole to retain the securement washer within the well, a C-shaped ring disposed partially within the circumferential groove at the inner surface of the securement washer, wherein the at least one circumferential groove of the bolt is adapted to receive the C-shaped ring when the security device is at least partially received through the hole and at a secured position,
wherein said portion of the end cap circumferential wall comprises tamper-evident indicia on a surface thereof, said tamper-evident indicia remaining unchanged until said security device is tampered with.

2. The security device of claim 1, wherein said tamper-evident indicia comprises a surface disturbance on the surface of said portion.

3. The security device of claim 1, wherein said tamper-evident indicia comprises one or more bumps on the surface of said portion.

4. The security device of claim 1, wherein said tamper-evident indicia comprises letters and/or numerals on the surface of said portion.

5. The security device of claim 4, wherein letters and/or numerals are raised above the surface of said portion.

6. The security device of claim 1, further comprising:
another end cap comprising:
a bolt head receiving well,
another end cap hole at an end region of the bolt head receiving well and through which the shaft of the bolt is disposed, and
another end cap circumferential wall extending longitudinally along and past the head of the bolt when the bolt head is received in the bolt head receiving well, said another end cap circumferential wall being configured to allow the bolt head to be received within the bolt head receiving well and to be closed at least partially around the head of the bolt after the bolt head is received in the bolt head receiving well.

7. (canceled)

8. The security device of claim 6, wherein said another end cap further comprises a label platform defining a label surface for label information.

9. The security device of claim 1, wherein said end cap further comprises a label platform defining a label surface for label information.

10. The security device of claim 1, wherein said end cap comprises plastic.

11. The security device of claim 8, wherein said end cap circumferential wall is folded over the securement washer so as to close said end cap around the securement washer.

12. A method of manufacturing a security device, comprising:
providing an end cap having a securement washer receiving well therein, said end cap having a wall that at least initially defines an opening at an end region of the securement washer receiving well;
inserting a securement washer through the opening and into the securement washer receiving well;
closing the wall of the end cap over a proximate circumferential portion of the securement washer so as to enclose the securement washer within the securement washer receiving well of the end cap; and
forming tamper-evident indicia on a surface of the end cap,
wherein said tamper-evident indicia remains unchanged until the security device is tampered with.

13. The method of claim 12, wherein said closing the wall of the end cap is carried out by an orbit forming process.

14. The method of claim 13, wherein said forming tamper-evident indicia is carried out by the orbit forming process.

15. The method of claim 12, wherein said closing the wall of the end cap is carried out by folding an end cap circumferential wall over the proximate circumferential portion of the securement washer.

16. The method of claim 12, wherein said forming tamper-evident indicia comprises forming one or more bumps on the surface of the end cap.

17. The method of claim 12, wherein said forming tamper-evident indicia comprises disturbing the surface of the end cap.

18. The method of claim 12, wherein said forming tamper-evident indicia comprises forming letters and/or numerals on the surface of the end cap.

19. The method of claim 12, wherein said forming tamper-evident indicia is performed simultaneously with said closing the end cap.

20. The method of claim 12, further comprising:
providing a bolt head end cap with a bolt head receiving well and a bolt head end cap hole at an end portion thereof;
inserting a shaft of a bolt though said bolt head end cap hole until a head of the bolt is seated in the bolt head receiving well; and
closing said bold head end cap around the head of the bolt so as to secure the head of the bolt within said bolt head end cap.

21. The method of claim 20, further comprising:
inserting an end of the bolt opposite the head into the securement washer; and mechanically coupling the bolt with the securement washer.

22. The method of claim 21, wherein said mechanically coupling is carried out via a C-shaped ring disposed within both a circumferential groove within the securement washer and at least one circumferential groove of the bolt when the security device is in a secured position.

23. The method of claim 20, further comprising:
providing a bolt head end cap label platform on said bolt head end cap; and
applying label information to said bolt head end cap label platform.

24. The method of claim 12, further comprising:
providing an end cap label platform on the end cap; and
applying label information to the end cap label platform.

25. The method of claim 24, wherein label information is applied to the end cap label platform by an inscribing process.

26. The method of claim 25, wherein the inscribing process comprises a laser inscribing process.
